(19) United States
(12) Patent Application Publication
(10) Pub. No.: US 2007/0275116 A1
(43) Pub. Date: Nov. 29, 2007

(54) Integral flash cooling manifold

(75) Inventors: Roy N. Krohn, Wrightsville, PA (US); Gregory Taylor, York, PA (US); Scott Gentzler, York, PA (US); Bernie Klingenmaier, York, PA (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(73) Assignee: Graham Packaging Company, L.P., York, PA (US)

(21) Appl. No.: 11/440,057

(22) Filed: May 25, 2006

(51) Int. Cl. B29C 45/00; B29B 11/06

(52) U.S. Cl. 425/552; 425/547

(57) ABSTRACT

A mold pair for molding a plastic container from a parison is provided. The mold pair has a first mold half and a second mold half. The first mold half has a cavity for forming the container, and a flash cooling system. The flash cooling system has a plurality of air distribution jets formed in the first mold half and for directing cooling air to a waste portion of the parison, and an air manifold formed in the first mold half and for directing the cooling air to the plurality of air distribution jets. The second mold half has a cavity for forming the container.

### BACKGROUND OF THE INVENTION

The invention relates to a container molding process. More particularly, the invention relates to systems for cooling flash or waste material between molds.

In some molding processes for molding plastic containers from a parison, a waste portion of the parison, often referred to as “gap flash”, can form between two adjacent mold pairs. This is particularly common in wheel type blow mold machines. This gap flash often does not cool sufficiently during the molding process and results in a sticky mess that can cause problems in the molding process and with the finished plastic container.

### SUMMARY OF THE INVENTION

The invention provides improved cooling of the gap flash by directing cooling air through a plurality of air jets to cool, and thus harden, the gap flash.

Embodiments of the invention provide a mold pair for molding a plastic container from a parison. The mold pair has a first mold half and a second mold half. The first mold half has a cavity for forming the container, and a flash cooling system. The flash cooling system has a plurality of air distribution jets formed in the first mold half and for directing cooling air to a waste portion of the parison, and an air manifold formed in the first mold half and for directing the cooling air to the plurality of air distribution jets. The second mold half has a cavity for forming the container.

Other embodiments of the invention provide a mold pair for molding a plastic container from a parison. The mold pair has a first mold half and a second mold half. Each of the first and second mold halves has a cavity for forming the container, and a flash cooling system. Each flash cooling system has a plurality of air distribution jets formed in the respective mold half and for directing cooling air to a waste portion of the parison, and an air manifold formed in the respective mold half and for directing the cooling air to the plurality of air distribution jets.

In particular embodiments of the invention, the air distribution jets and the air manifolds are machined directly into the mold halves.

### BRIEF DESCRIPTION OF THE DRAWINGS

The invention is explained below in further detail with the aid of exemplary embodiments shown in the drawings, wherein:

FIG. 1 is an end view of a mold pair in accordance with an embodiment of the invention; and

FIG. 2 is a cross sectional view along section line I-I in FIG. 1.

### DETAILED DESCRIPTION OF THE INVENTION

The invention is explained in the following with the aid of the drawings in which like reference numbers represent like elements.

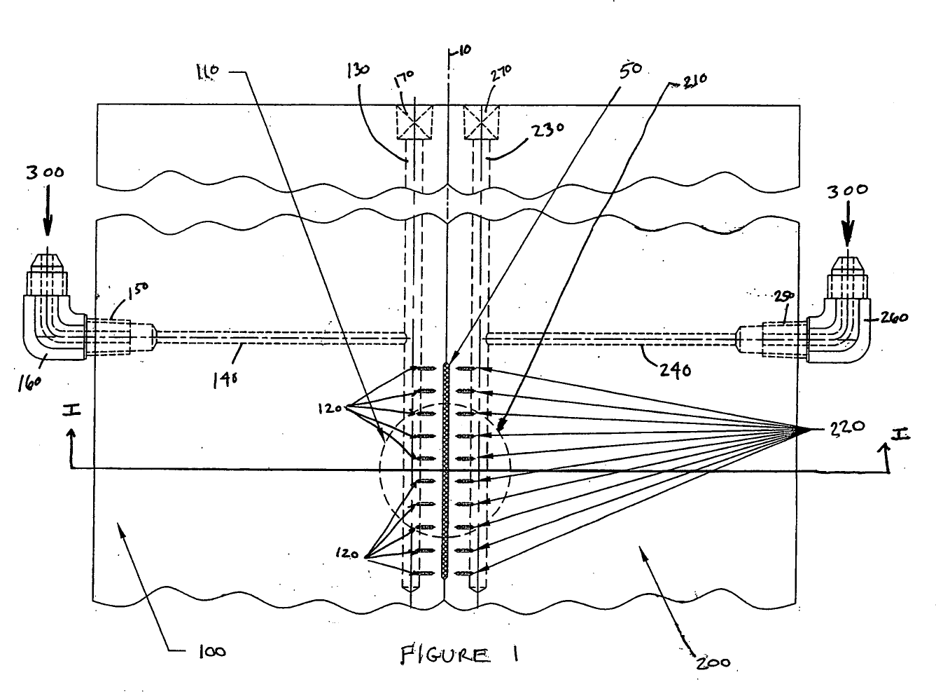

FIG. 1 shows a partial view of a pair of molds halves in accordance with the invention, first mold half 100 and second mold half 200. Mold halves 100, 200 come together and meet at parting line 10 to form a mold for molding a plastic container. In this example, the mold halves 100, 200 form one of a plurality of molds on a wheel type blow molding machine. In the blow molding process, mold halves 100, 200 come together around a parison which is then inflated to form at least one plastic container within cavities in the mold halves. In this example, mold half 100 has one cavity 110 and second mold half 200 has one cavity 210. However, it is noted that the mold halves can each have more than one cavity.

Also shown in FIG. 1 is a second pair of mold halves 1000, 2000 having cavities 1100, 1200. After mold halves 100, 200 have closed around the parison, they move away from the source of the parison and mold halves 1000, 2000 close around a subsequent portion of the parison to form another container or containers. There can be a gap between adjacent mold pairs (in this example, between the mold pair 100, 200 and the mold pair 1000, 2000) which results in a portion of the parison not being inside either mold pair. This portion is called the “gap flash” and is designated by 50 in the figures. The figures also show compression flash 60, 600 which is waste material that exists inside the mold pairs. The container and the compression flash generally are cooled during the molding process by a cooling water loop within the mold halves. The gap flash, however, is not normally cooled by the cooling water and, therefore, can remain molten and sticky. If the gap flash is not properly cooled prior to the container being ejected from the mold, the container may be ejected unevenly and/or long strands of plastic can be formed that cause problems with subsequent molding.

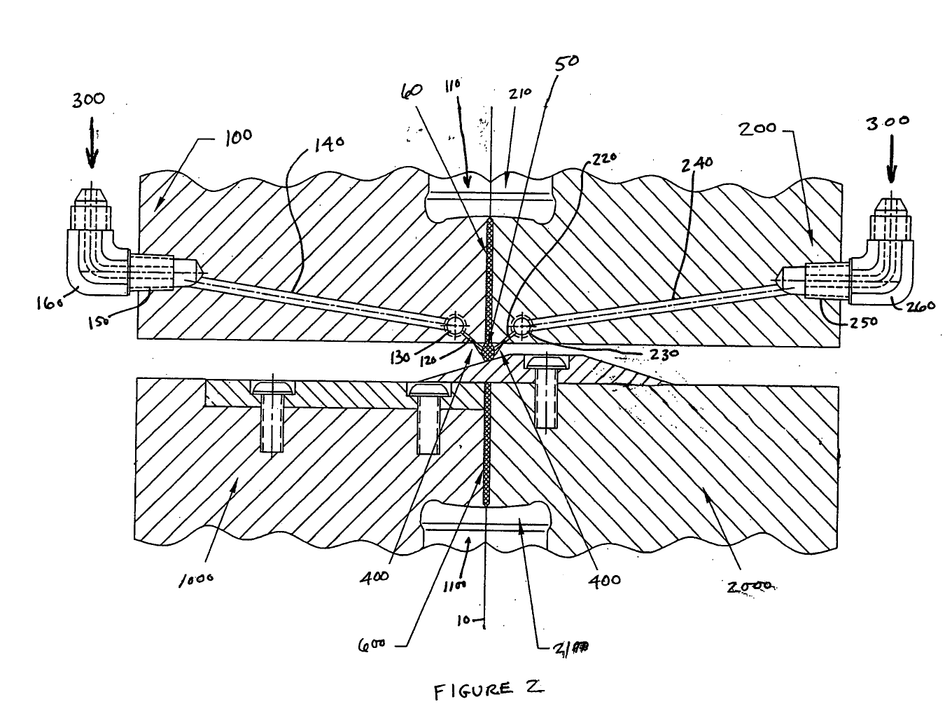

FIGS. 1 and 2 show a plurality of cooling jets 120 formed in first mold half 100. Cooling jets 120 are in fluid communication with an air manifold 130 which is in turn in fluid communication with an air supply duct 140. In this example, an air supply fitting 160 is fitted into an air supply fitting receptacle 150 that is formed in the end of air supply duct 140. Supply air (indicated by arrow 300) is introduced into air supply fitting 160 and is ultimately exhausted out of cooling jets 120 as cooling air 400. Cooling air 400 is directed at gap flash 50 to cool and harden it.

Similarly, second mold half 200 can be provided with a plurality of cooling jets 220 formed in second mold half 200. Cooling jets 220 are in fluid communication with an air manifold 230 which is in turn in fluid communication with an air supply duct 240. In this example, an air supply fitting 260 is fitted into an air supply fitting receptacle 250 that is formed in the end of air supply duct 240. Supply air (indicated by arrow 300) is introduced into air supply fitting 260 and is ultimately exhausted out of cooling jets 220 as cooling air 400. Cooling air 400 is directed at gap flash 50 to cool and harden it.

By supplying the air to the gap flash 50 through a plurality of spaced apart cooling jets, gap flash 50 is cooled substantially uniformly across its length, as shown in FIG. 1. In this example, cooling jets 120, 220 are angled relative to parting line 10 of the mold pair. The cooling jets can all be angled to the same degree, or can be angled differently. In particular embodiments, cooling jets 120, 220 are angled at between 20 degrees and 70 degrees relative to parting line 10.

Cooling jets 120, 220, air manifolds 130, 230, and air supply ducts 140, 240 can be machined directly in the mold halves. In this example, plugs 170, 270 are fitted into the ends of air manifolds 130, 230, respectively, to seal them after machining. By placing air supply fittings 160, 260 on outside faces of the mold halves that are opposite the cavities, they do not interfere with any mold operations.

The timing of the cooling air can be controlled by using an air circuit that is parallel to the air used to blow the container. By doing this, no additional cams, valves or other timing devices are needed.

The invention has been described in detail with respect to preferred embodiments and it will now be apparent from the foregoing to those skilled in the art that changes and modifications may be made without departing from the invention in its broader aspects. The invention, therefore, is intended to cover all such changes and modifications that fall within the true spirit of the invention.

What is claimed is:

1. A mold pair for molding a plastic container from a parison, the mold pair comprising:
a first mold half having
a cavity for forming the container, and
a first flash cooling system having
a first plurality of air distribution jets formed in the first mold half and for directing cooling air to a waste portion of the parison, and
a first air manifold formed in the first mold half and for directing the cooling air to the first plurality of air distribution jets; and
a second mold having a cavity for forming the container.

2. The mold pair of claim 1, wherein the first plurality of air distribution jets and the first air manifold are machined directly into the first mold half.

3. The mold pair of claim 2, wherein the first plurality of air distribution jets are at a first angle relative to a mold pair parting line, the first angle being less than 90 degrees.

4. The mold pair of claim 3, wherein the first angle is between 20 degrees and 70 degrees.

5. The mold pair of claim 1, wherein the second mold half has
a second flash cooling system having
a second plurality of air distribution jets formed in the second mold half and for directing cooling air to the waste portion of the parison, and
a second air manifold formed in the second mold half and for directing the cooling air to the second plurality of air distribution jets.

6. The mold pair of claim 5, wherein the first plurality of air distribution jets and the first air manifold are machined directly into the first mold half, and
the second plurality of air distribution jets and the second air manifold are machined directly into the second mold half.

7. The mold pair of claim 6, wherein the first plurality of air distribution jets are at a first angle relative to a mold pair parting line, the first angle being less than 90 degrees, and
the second plurality of air distribution jets are at a second angle relative to the mold pair parting line, the second angle being less than 90 degrees.

8. The mold pair of claim 7, wherein the first angle is between 20 degrees and 70 degrees, and the second dangle is between 20 degrees and 70 degrees.

9. The mold pair of claim 6, further comprising
a first air supply duct in the first mold half that directs the cooling air to the first air manifold; and
a second air supply duct in the second mold half that directs the cooling air to the second air manifold.

10. The mold pair of claim 9, wherein the first air supply duct is machined directly into the first mold half, and the second air supply duct is machined directly into the second mold half.

11. The mold pair of claim 10, further comprising a first air supply fitting receptacle in the first mold half, the first air fitting receptacle being fluidly connected to the first air supply duct,
wherein the first air supply fitting receptacle is for receiving a first air supply fitting.

12. The mold pair of claim 11, wherein the first air supply fitting receptacle is located in an outside face of the first mold half that is opposite the cavity in the first mold half.

13. The mold pair of claim 12, further comprising a second air supply fitting receptacle in the second mold half, the second air fitting receptacle being fluidly connected to the second air supply duct,
wherein the second air supply fitting receptacle is for receiving a second air supply fitting.

14. The mold pair of claim 13, wherein the second air supply fitting receptacle is located in an outside face of the second mold half that is opposite the cavity in the second mold half.

15. The mold pair of claim 6, wherein the cooling air supply to the first and second flash cooling systems is automatically timed by a blowing cycle of blow air used to blow a plastic container in the mold pair.

16. The mold pair of claim 2, wherein the cooling air supply to the first flash cooling system is automatically timed by a blowing cycle of blow air used to blow a plastic container in the mold pair.
